(19) United States
(12) Patent Application Publication
(10) Pub. No.: US 2009/0109171 A1
(43) Pub. Date: Apr. 30, 2009

(54) Display Device and Display Method

(75) Inventor: Masao Akaiwa, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: SEIKO EPSON CORPORATION, Tokyo (JP)

(21) Appl. No.: 12/247,054

(22) Filed: Oct. 7, 2008

(30) Foreign Application Priority Data
Oct. 24, 2007 (JP) 2007-276354

(51) Int. Cl. G09G 3/34

(52) U.S. Cl. 345/107

(57) ABSTRACT

A display device having a display panel having an electrophoretic device, and a drive control that controls displaying content on the display panel. The drive control evaluates the display data displayed on the display panel and changes the refresh time interval of the display panel according to the content of the display data.

### CROSS-REFERENCE TO RELATED APPLICATIONS

Japanese Patent application No. 2007-276354 is hereby incorporated by reference in its entirety.

### BACKGROUND

1. Field of Invention

The present invention relates to a display device and a display method.

2. Description of Related Art

Display devices that operate using electrophoresis, commonly called electrophoretic displays, are known from the literature. An electrophoretic display is a type of display device that remembers what is displayed even when power is not supplied and continues displaying the same content for some period of time, and is a form of electronic paper or e-paper.

Japanese Unexamined Patent Appl. Pub. JP-A-2007-65258 is directed to an electrophoretic display device that applies different voltages to two or more different display units that are rewritten at different write intervals. In a timepiece this method can be used to apply a different voltage to separate display units for the month, day, hour, minute, and second.

The electrophoretic display device to which JP-A-2007-65258 is directed suppresses ghosts and unnecessary power consumption by applying higher voltages to the electrophoretic devices that display the display units with a longer rewrite interval.

Even this control method is subject to display degradation, however. More specifically, an electrophoretic display device works by applying voltage to cause black and white electrophoretic particles to migrate as needed to display the desired content. As a result, if voltage is not applied for a long time, some of the electrophoretic particles will move and the display will become degraded where thin lines are displayed, which is particularly noticeable in high resolution text and images.

### SUMMARY OF INVENTION

The display device and display method according to the present invention prevent degradation of the display while also suppressing power consumption.

A display device according to a preferred embodiment of the invention has a display panel having an electrophoretic device, and a drive control means that controls displaying content on the display panel. The drive control means evaluates the display data displayed on the display panel and changes the refresh time interval of the display panel according to the content of the display data.

A display method according to another aspect of the invention is a display method for a display device with a display panel having an electrophoretic device, including a step of evaluating the display data displayed on the display panel and changing the refresh time interval of the display panel according to the content of the display data.

The invention thus changes the refresh time interval based on the content of the display data, such as the detail in the display data, and can therefore prevent degradation of the text or image displayed on the display panel.

More particularly, fine lines in the text or image can easily affect the display quality of the text or image due to degradation of the display when the text size is small or the image is detailed. Display degradation can be prevented and the display quality of the text and image can be maintained in this situation by setting a short refresh interval.

However, when lines in the text or image are heavy, such as when the text size is large or the image is simple, the display quality of the text or image is not easily affected by display degradation. The display quality of the text or image can therefore be maintained even if the refresh time interval is longer, and power consumption can be reduced by thus reducing how often the display is refreshed.

The invention thus changes the refresh time interval according to the display content, and power consumption can be minimized while maintaining display quality.

In another aspect of the invention the drive control means refreshes the display at a first refresh time interval when text data displaying text is contained in the display data and the display size of the text is smaller than a preset predetermined size, and refreshes the display at a second refresh time interval that is longer than the first refresh time interval when text data displaying text is contained in the display data and the display size of the text is greater than or equal to the preset predetermined size.

When text is displayed on the display panel and the character size is smaller than a predetermined size, the width of the lines forming the characters is thin and the quality of the displayed text cannot be maintained if parts are lost. Display degradation can therefore be prevented by refreshing the display at a short interval set by the first refresh time interval.

However, if the character size is greater than or equal to the predetermined size, the width of the lines forming the characters is wide. The display quality can therefore be maintained even if the display is refreshed at a second refresh time interval that is longer than the first refresh time interval. Power consumption can also be reduced by thus increasing this refresh time interval, which is the time between the timing at which power is applied to the display.

In another aspect of the invention the drive control means refreshes the display at a first refresh time interval when text data displaying text is contained in the display data and the font type of the text is a preset first font type, and refreshes the display at a second refresh time interval that is longer than the first refresh time interval when text data displaying text is contained in the display data and the font type of the text is a preset second font type.

Preferably, the first font type is a font in which the thickness of the lines rendering the characters varies, and the second font type is a font in which the thickness of the lines rendering the characters is substantially constant.

The first font type could be a Mincho or serif font, and the second font type could be a Gothic or sans serif font.

When text is displayed on the display panel and the character font is a serif font such as Mincho in which the thickness of parts of the lines forming the characters is thin, the quality of the displayed characters cannot be maintained if thin parts of the lines fade. Display degradation can be prevented in this situation by refreshing the display at a short refresh interval set by the first refresh time interval.

If the character font is a sans serif font such as Gothic, the thickness of the lines forming the characters is wider. The display quality can therefore be maintained by refreshing the display at a second refresh time interval that is longer than the first refresh time interval. Power consumption can also be reduced by using a longer refresh time interval, which is the time between the timing at which power is applied.

In a display device according to another aspect of the invention the drive control means refreshes the display at a first refresh time interval when image data displaying an image is contained in the display data and the image is determined to be a detailed image, and refreshes the display at a second refresh time interval that is longer than the first refresh time interval when the image is determined to be a simple image.

If an image is displayed on the display panel and the image is detailed, parts with narrow lines will typically be contained in the image. These thin line parts can easily fade and the quality of the displayed image cannot be maintained for a long period of time. Degradation of the displayed image can therefore be prevented by refreshing the display at a short interval set by the first refresh time interval.

If the image is a simple image, however, there will not be parts with detailed lines. The image quality of the displayed image can therefore be maintained even if the display is refreshed at a second refresh time interval that is longer than the first refresh time interval. Power consumption can also be reduced by using a longer refresh time interval, which is the time between the timing at which power is applied.

In according to another aspect of the invention the drive control means refreshes the display at the first refresh time interval when text data displaying text and image data displaying an image is contained in the display data.

When both text and image data are displayed on the display panel, the display content is complex and the quality of the displayed text and image cannot be maintained for a long time. Display degradation can therefore be prevented in this situation by refreshing the display at a short interval set by the first refresh time interval.

The invention thus prevents display degradation while also suppressing power consumption by appropriately changing the rewrite interval according to the display resolution.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a front view of a timepiece according to a first embodiment of the invention.

FIG. 2 is a block diagram of the circuit configuration of a timepiece according to this embodiment of the invention.

FIG. 3 is a section view of the display panel in this embodiment of the invention.

FIG. 4 schematically describes the microcapsules in this embodiment of the invention.

FIG. 5 is a flow chart describing the display process in this embodiment of the invention.

FIG. 6 is a front view of a timepiece with a calendar display mode in this embodiment of the invention.

FIG. 7 is a front view of a timepiece with a data display mode in this embodiment of the invention.

FIG. 8 is a front view of a timepiece according to a second embodiment of the invention.

FIG. 9 is a front view of a timepiece according to a second embodiment of the invention.

FIG. 10 is a front view of a timepiece according to a third embodiment of the invention.

FIG. 11 is a front view of a timepiece according to a third embodiment of the invention.

FIG. 12 is a flow chart describing the display process of the third embodiment of the invention.

FIG. 13 is a table showing refresh time interval settings in another embodiment of the invention.

### DESCRIPTION OF THE PREFERRED EMBODIMENTS

Preferred embodiments of the present invention are described below with reference to the accompanying figures. Note that parts that are functionally the same as parts that have already been described are identified by the same reference numerals, and further description thereof is omitted.

### Embodiment 1

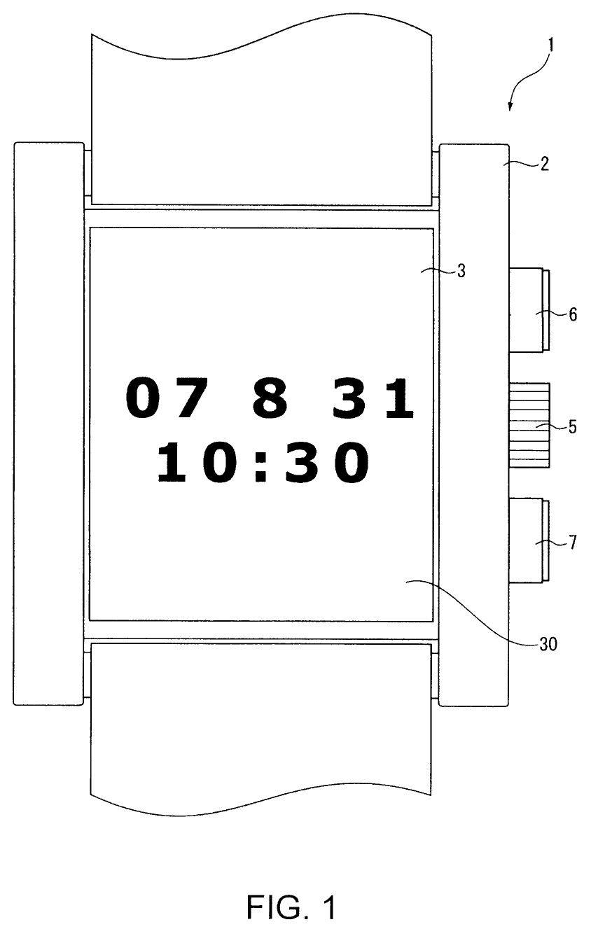

A first embodiment of the invention is described next with reference to FIG. 1 to FIG. 7.

1. General Configuration

FIG. 1 is a front view of an electronic timepiece 1 described by way of example as a display device according to a preferred embodiment of the invention. The electronic timepiece 1 has a rectangular case 2 and a display module 3. A crown 5, and buttons 6 and 7 are disposed to the case 2.

2. Display Module

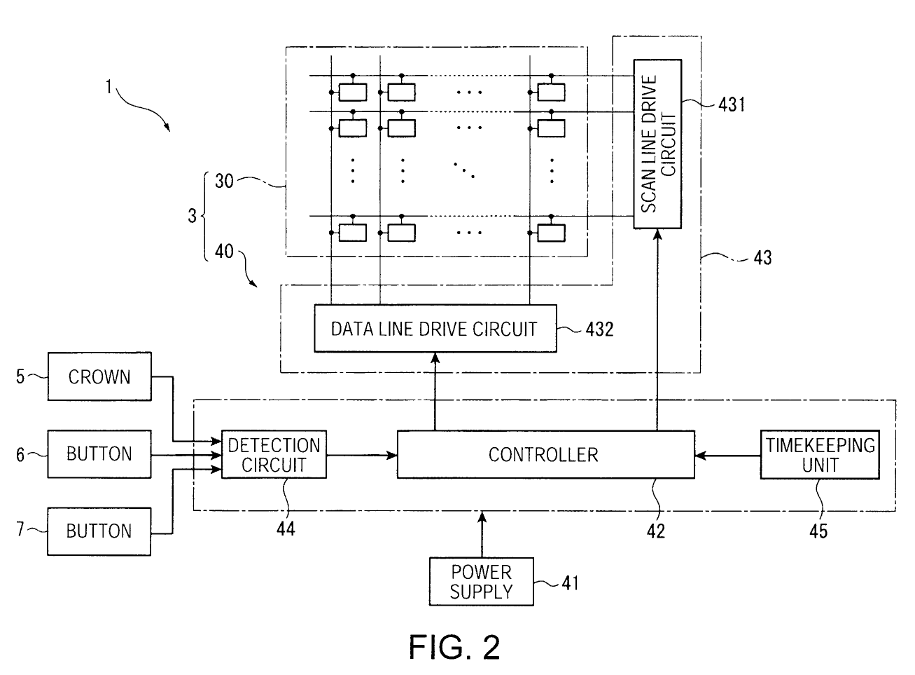

As shown in FIG. 2 the case 2 includes a display panel 30 and a drive control means 40 that drives the display panel 30 and includes a timekeeping unit.

3. Drive Control Means

The drive control means 40 includes a power supply 41, a controller 42 that controls the electronic timepiece 1, a drive circuit 43 composed of a driver IC chip that controls displaying content on the display panel 30, a detection circuit 44 for detecting operation of the crown 5 and the buttons 6 and 7, and a timekeeping unit 45 that includes a crystal oscillation circuit and keeps the time.

The controller 42 controls the drive circuit 43, and includes an image signal processing circuit and timing generator not shown. The controller 42 generates the display data for the images and text displayed on the display panel 30 and the refresh data that sustains the display, and outputs the generated data to the drive circuit 43.

The drive circuit 43 controls the display panel 30 based on signal output from the controller 42. As further described below, the display panel 30 in this embodiment of the invention is an active matrix drive device and has a TFT circuit for driving the picture elements.

As a result, the drive circuit 43 has a scan line drive circuit 431 that outputs a predetermined scan line signal to the scan lines of the TFT circuit, and a data line drive circuit 432 that outputs predetermined data line signals to the data lines of the TFT circuit.

The controller 42 has a function for changing the font type and size of text displayed on the display panel 30 in response to button operations.

As shown in Table 1, the controller 42 stores the refresh time interval corresponding to the selected font type and size.

TABLE 1

| FONT TYPE | SIZE | REFRESH TIME INTERVAL |
|---|---|---|
| sans serif | large | long |
| sans serif | medium | long |
| sans serif | small | short |
| Serif | large | long |
| Serif | medium | short |
| Serif | small | short |

As shown in Table 1, a serif or sans serif font can be selected in this embodiment of the invention. A plurality of font sizes can also be selected, such as 8, 10, 12, 14, 16, and 18 point.

The refresh time interval is set according to the font type (serif or sans serif) and the font size.

The font sizes are divided into three groups in this embodiment of the invention with font sizes less than or equal to a predetermined font size FS1 (such as 10 point) being small, sizes that are larger than FS1 and less than or equal to font size FS2 (such as 14 point) being medium, and sizes that are larger than font size FS2 being large.

As shown in Table 1, if the font type is sans serif and the font size is larger than the predetermined font size FS1, that is, the size is large or medium, the refresh time interval is set long. If the font type is sans serif but the font size is less than or equal to the predetermined font size FS1, that is, the font size is small, the refresh time interval is set short.

If the font type is serif and the size is greater than or equal to the predetermined font size FS2, that is, the size is large, the refresh time interval is set long. However, if the font type is serif and the size is less than or equal to the predetermined font size FS2, that is, the size is medium or small, the refresh time interval is set short.

The specific time of these long and short refresh time intervals can be set according to the display size of the text. In this embodiment of the invention the time is 60 minutes if the refresh time interval is long, and is 20 minutes if the refresh time interval is short. As a result, the display is refreshed once an hour if the refresh time interval is long, and is refreshed three times an hour if the interval is short.

4. Display Panel

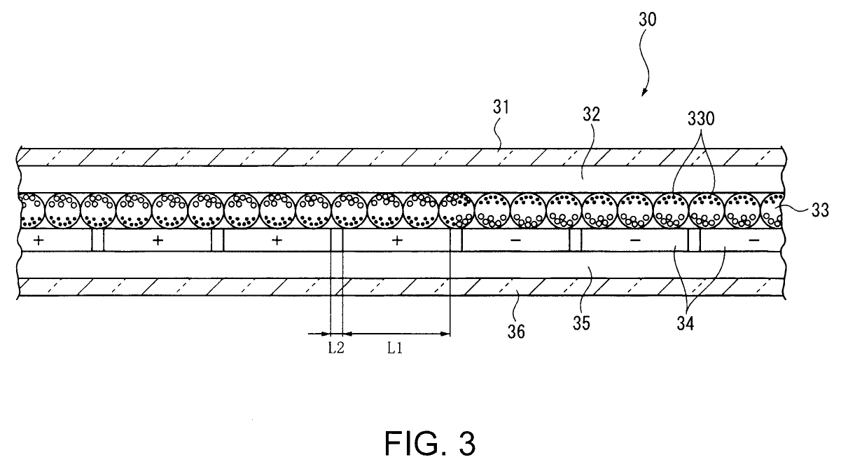

As shown in FIG. 3, the display panel 30 is a layered construction having in order from the display side a front glass 31, a common electrode 32, an electrophoretic layer 33, pixel electrodes 34, a TFT circuit layer 35, and a back glass 36. The front glass 31 and back glass 36 are not limited to transparent glass, and could be made of a transparent plastic.

The TFT circuit driven by the scan line drive circuit 431 and data line drive circuit 432 is rendered in the TFT circuit layer 35. The TFT circuit layer 35 includes switching transistors and holding capacitances not shown. Each transistor is connected to a pixel electrode 34, which are disposed for each pixel of the display.

The common electrode 32 is made from a transparent electrode material such as indium tin oxide (ITO). The common electrode 32 is disposed over substantially the entire area of the display panel 30. In other words, the pixel electrodes 34 are disposed for each pixel of the display panel 30, but the common electrode 32 is common to each of the pixels.

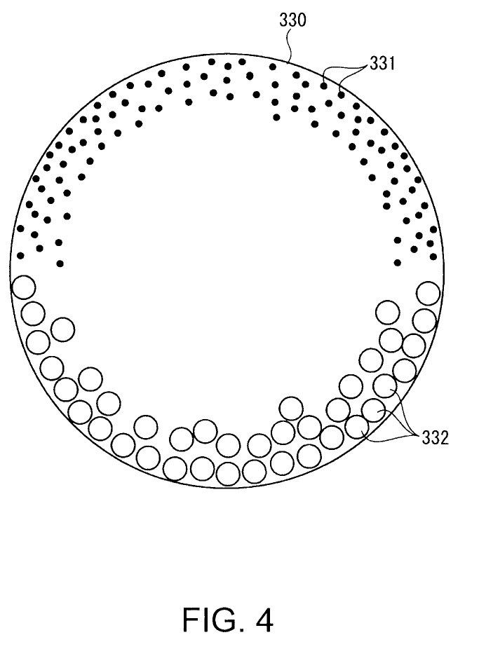

The electrophoretic layer 33 includes numerous microcapsules 330 bonded to the common electrode 32. As also shown in FIG. 4, the microcapsules 330 are filled with an electrophoretic particle suspension fluid in which numerous charged particles are dispersed. Both black electrophoretic particles (“black particles” below) 331 and white electrophoretic particles (“white particles” below) 332 are dispersed in the electrophoretic particle suspension fluid, rendering an electrophoretic layer with a two color particle dispersion. The black particles 331 and white particles 331 are charged to opposite polarities, and in this embodiment of the invention the black particles 331 are negatively charged while the white particles 331 are positively charged.

The diameter of the microcapsules 330 in this embodiment of the invention is approximately 30 μm (0.03 mm), the diameter of the 331 is 10-display panel 30 nm, and the diameter of the white particles 331 is 100-300 nm.

As shown in FIG. 3, the width L1 of the pixel electrodes 34 is approximately 0.09 mm, and the width L2 of the gap between the pixel electrodes 34 is approximately 0.01 mm.

The sides of the display panel 30 are sealed with a sealing material between the front glass 31 and back glass 36. The front glass 31, back glass 36, and sealing material render thus render a sealed enclosure containing the electrophoretic layer 33 and other internal components.

5. Displaying Content Using Electrophoresis

When a potential difference is created between the common electrode 32 and pixel electrodes 34, the black particles 331 and white particles 331 in the microcapsules 330 migrate and the color displayed by each microcapsule 330 changes when seen from the front glass 31 side.

More specifically, when the pixel electrodes 34 goes to a low potential (L potential, denoted “−” in FIG. 3) and the common electrode 32 goes high (H potential), the potential difference creates a field from the common electrode 32 to the pixel electrodes 34, causing the positively charged white particles 331 to move to the pixel electrode 34 side and the negatively charged black particles 331 to move to the common electrode 32 side. As a result, when the potential of the pixel electrode 34 is low relative to the potential of the common electrode 32, the display color becomes black when seen from the front glass 31 side.

When the field is reversed from this black display by driving the pixel electrode 34 to a high potential (H potential, denoted “+” in FIG. 3) and the common electrode 32 to a low potential (L potential), reversal of the field changes the color displayed on the display panel 30 to white.

Gray levels between black and white can also be displayed by changing the time voltage is applied to adjust the distance moved by the black particles 331 and white particles 331.

When applying the field stops, movement of the black particles 331 and white particles 331 also stops, and the color displayed at that time remains displayed. However, if no voltage is applied for a long time, some of the particles will move and the display of the fine line parts of images and text will be degraded.

6. Driving the Display Panel

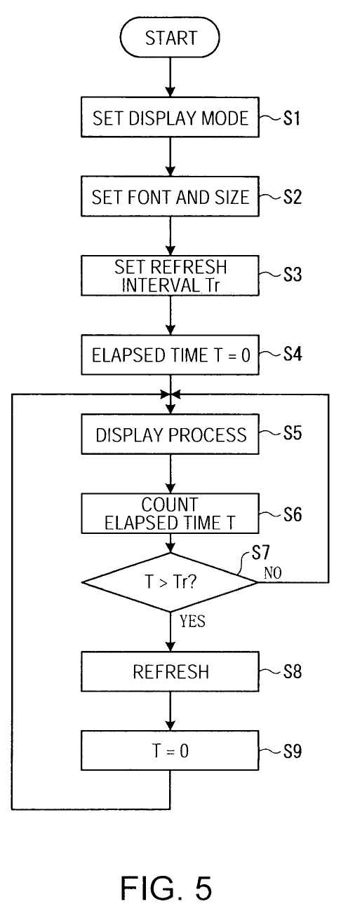

The drive process for driving the display panel 30 is described next with reference to the flow chart in FIG. 5.

The controller 42 first sets the content to be displayed on the display panel 30, that is, sets the display mode (S1).

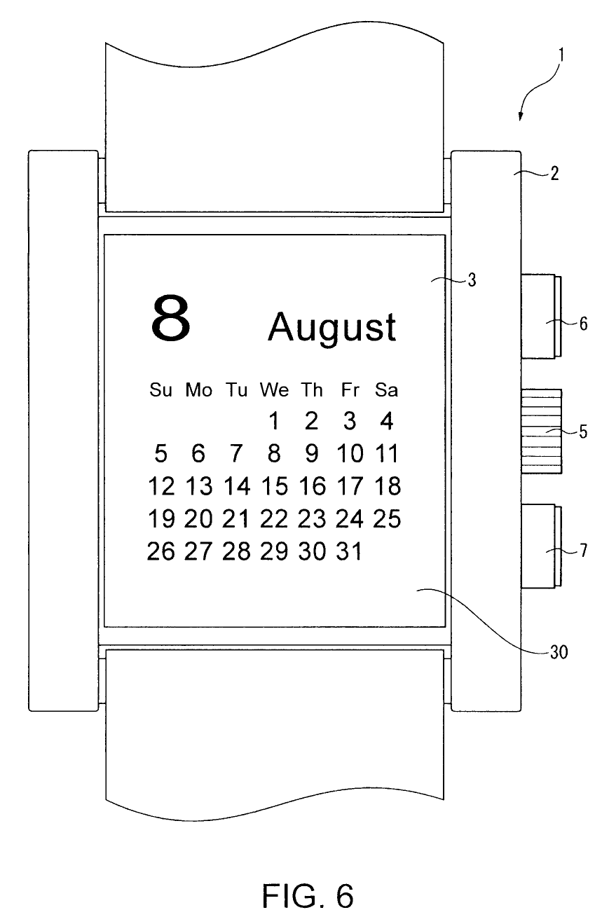

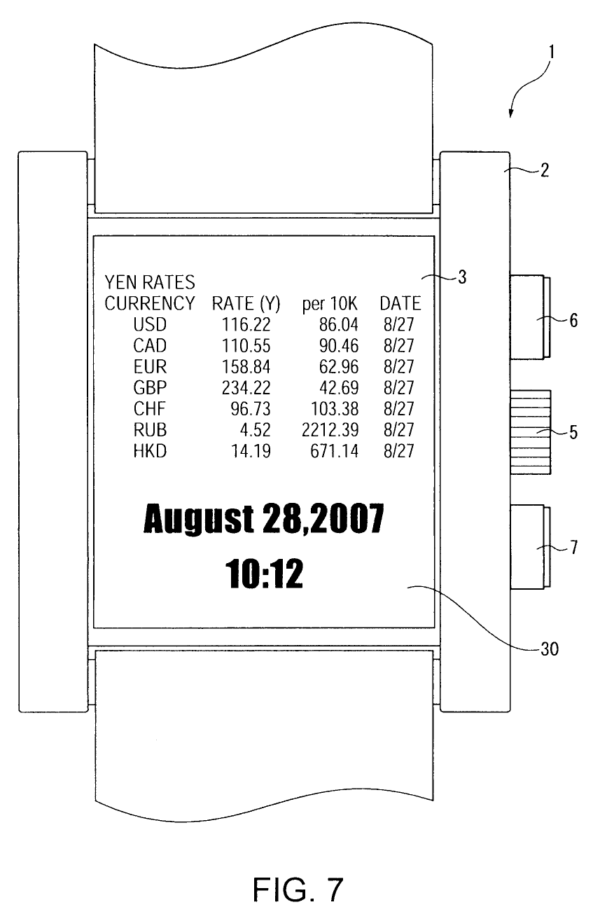

The electronic timepiece 1 according to this embodiment of the invention can be selectively set to a time display mode displaying the date (year, month, day) and the time (hour and minute) as shown in FIG. 1, a calendar display mode displaying a monthly calendar as shown in FIG. 6, or a data display mode displaying information such as exchange rates as shown in FIG. 7.

The display modes are selected by the user operating the crown 5 or buttons 6 and 7. The controller 42 determines and sets the selected display mode based on the operating signal output from the detection circuit 44.

The controller 42 then sets the font type and size of the characters displayed on the display panel 30 (S2).

The font type and size are initially set according to the display mode. For example, in the time display mode shown in FIG. 1 the date and time are displayed with a large sans serif font.

Except for certain information, content is displayed with a small sans serif font in the calendar display mode shown in FIG. 6 and the data display mode shown in FIG. 7.

The user could also be enabled to change the font type and size using the buttons 6 and 7. In this case the controller 42 sets the font type and size based on the signal output from the detection circuit 44.

The controller 42 then sets the refresh interval Tr according to the selected font type and size (S3). As shown in Table 1, if the font is sans serif and the size is medium or large, the controller 42 sets the refresh interval Tr to a long interval of 1 hour, that is, an interval at which the display is refreshed once an hour.

If the font is serif and the size is large, the controller 42 also sets the refresh interval Tr to 1 hour, that is, a long interval.

However, if a small sans serif font is set, or a small or medium serif font is set, the refresh interval Tr is set to 20 minutes or a short interval and the display is refreshed three times in one hour.

Therefore, when the time display mode shown in FIG. 1 is selected, the refresh time interval is set long, and when the calendar display mode in FIG. 6 or the data display mode in FIG. 7 is selected the refresh time interval is set short.

Note that in the example shown in FIG. 6 the number and letters for the month (“8” and “August” in FIG. 6) can be displayed using medium size characters and the refresh time interval in this part can be set long, but because this embodiment of the invention uses a common electrode 32 and prioritizes preventing display degradation in the small text size area, the entire display panel 30 is set to a short refresh interval. In FIG. 7 the date and time are also displayed with medium size text, and a short refresh time interval is set for the entire display panel 30 for the same reason.

In order to measure the refresh time interval, the controller 42 initializes the elapsed time T to 0 (S4).

The controller 42 then executes the display process appropriate to the selected display mode (S5). For example, in the time display mode as shown in FIG. 1 the controller 42 displays the date (year, month, day) and the time (hour, minute) on the display panel 30. In the calendar display mode, the controller 42 displays a monthly calendar on the display panel 30 as shown in FIG. 6, and displays information such as exchange rates on the display panel 30 in the data display mode as shown in FIG. 7.

The controller 42 then measures the elapsed time T after starting the time display based on signals from the timekeeping unit 45 (S6).

The controller 42 then checks if the elapsed time T exceeds the refresh interval Tr (S7).

If the elapsed time T does not exceed the refresh interval Tr, the controller 42 continues the display process (S5) and the elapsed time measuring process (S6).

If the elapsed time T exceeds the refresh interval Tr in S7, the controller 42 refreshes the display (S8). To refresh the display the controller 42 reapplies a voltage based on the data currently being displayed. By thus reapplying voltage, the distribution state of the electrophoretic particles (black particles 331 and white particles 331) that were distributed to display the desired image or characters (numbers) by applying voltage to the common electrode 32 and pixel electrodes 34 can be stabilized or sustained.

For example, in the example in FIG. 1 the minute value of the time is updated each minute but the hour value is not updated until one hour passes. The date display is also not updated until at least one day has passed. Therefore, if voltage is applied only when the displayed data changes, the time until voltage is applied is particularly long in the date display, for example, and the display degrades.

However, because the display is refreshed at the rate of once an hour when the refresh interval is long and three times an hour when the refresh interval is short, voltage is also reapplied to the date display data and the display is prevented from degrading.

After refreshing the display the controller 42 resets the elapsed time T to 0 (S9). The controller 42 then repeats the display process (S5) and the elapsed time measuring process (S6).

If the crown 5 or buttons 6 and 7 are operated to select the display mode or to select the font type or size, the controller 42 executes the process from S1 to S9 again.

This embodiment of the invention has the following effect.

(1) Because the display is refreshed at a regular interval when displaying time or other information on the display panel 30, the display is prevented from degrading even when data with a long update interval, such as the date, is displayed.

Furthermore, because the refresh time interval is changed according to the display content and more particularly according to the font type and size, and the refresh time interval is short when the font type or size has fine parts where the display degrades easily, display degradation can be prevented. In addition, because the refresh time interval is long when the font type or size have a heavier line width and the display does not degrade easily, power consumption can be reduced.

More specifically, because this embodiment of the invention changes the refresh time interval according to the font type and size of the displayed numbers or letters, that is, according to the content of the displayed image, appropriate image quality can be maintained, the display is not refreshed unnecessarily, and power consumption can be reduced.

(2) The processing load on the controller 42 is also reduced because the refresh time interval is preset based on the font type and size.

### Embodiment 2

A timepiece according to a second embodiment of the invention is described next.

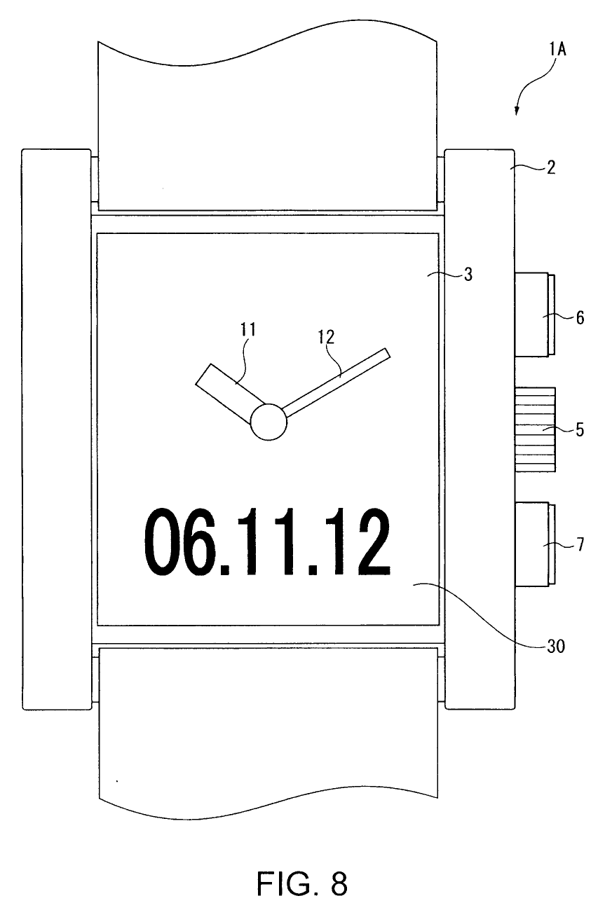

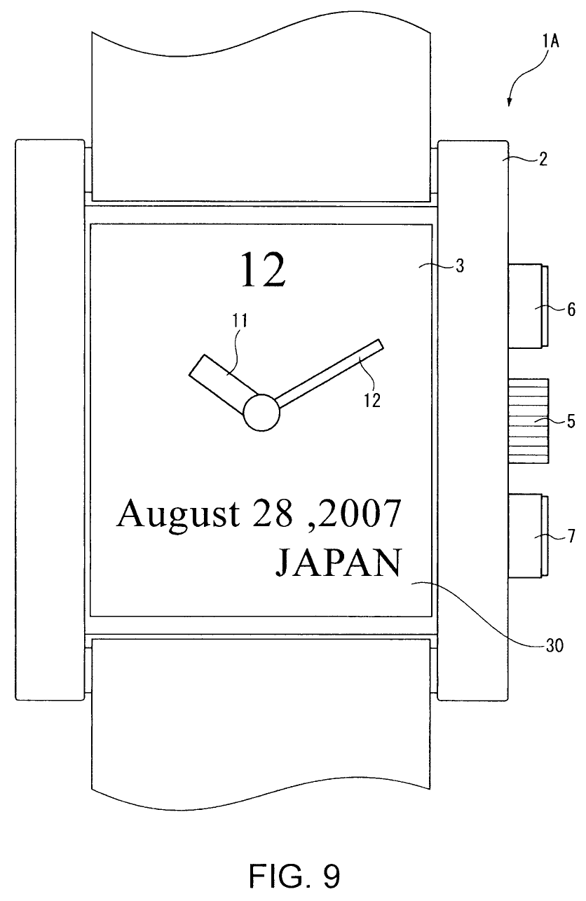

As shown in FIG. 8 and FIG. 9, the timepiece 1A according to the second embodiment of the invention is a combination timepiece having an hour hand 11 and minute hand 12 in addition to a display panel 30.

Because the time is indicated with the hour hand 11 and minute hand 12, this timepiece 1A displays only the date (year, month, day) on the display panel 30 and does not display the hour and minute.

As in the timepiece 1 according to the first embodiment of the invention, this timepiece 1A also enables setting the font type and size of the numbers used to display the date on the display panel 30, and the refresh time interval is set according to the font type and size. The display panel of this timepiece 1A can therefore be driven using the same drive process used to control the display panel of the timepiece 1 described above.

For example, the timepiece 1A shown in FIG. 8 is set to a sans serif font with a large font size. The refresh time interval is therefore long, and the display is refreshed once an hour.

The timepiece 1A shown in FIG. 9 is set to use a serif font and a large font size. The refresh time interval is therefore also long, and the display is refreshed once an hour.

This embodiment achieves the same effects (1) and (2) as the first embodiment described above.

More particularly, because only the date is displayed on the display panel 30 of this timepiece 1A, the display is redrawn and updated only once a day, and the possibility of display degradation is therefore greater if the display is not refreshed.

However, by refreshing the display once an hour or every 20 minutes as described above, the timepiece 1A according to this embodiment of the invention can also prevent the display of the date from degrading.

### Embodiment 3

A timepiece according to a third embodiment of the invention is described next.

Similarly to the timepiece 1A described above, the timepiece 1B according to the third embodiment of the invention is a combination timepiece having an hour hand 11, minute hand 12, and second hand 13.

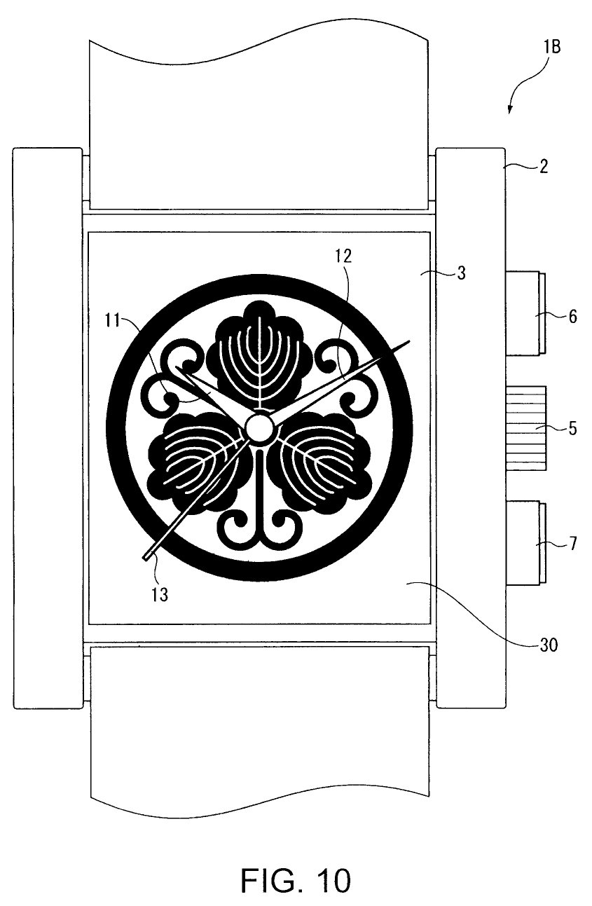

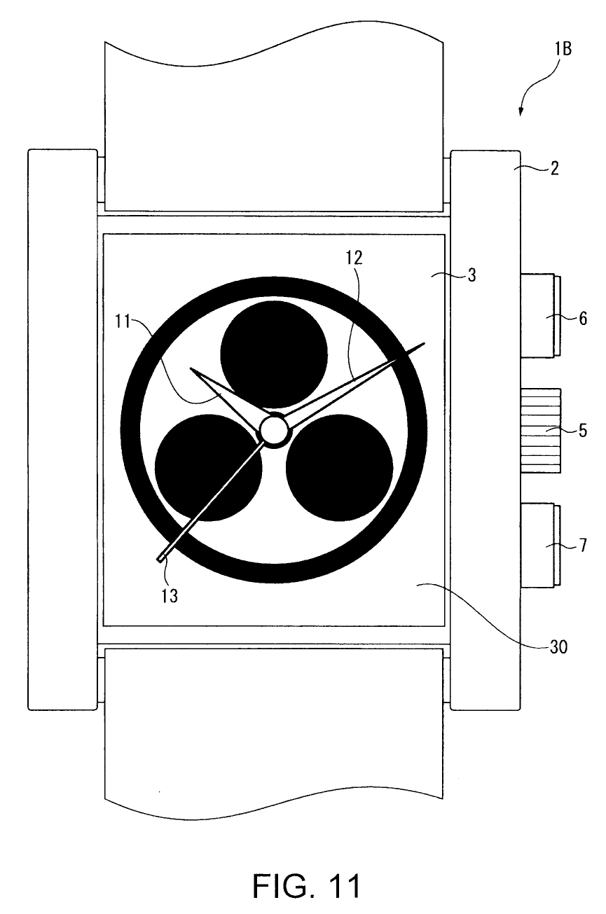

As shown in FIG. 10 and FIG. 11, an image is displayed on the display panel 30 of this timepiece 1B. This embodiment of the invention uses an electrophoretic display device that can display detailed images for the display panel 30, and can therefore also display fine (detailed) images.

The timepiece 1B according to this embodiment of the invention therefore sets the refresh time interval based on the resolution or degree of detail in the image displayed on the display panel 30.

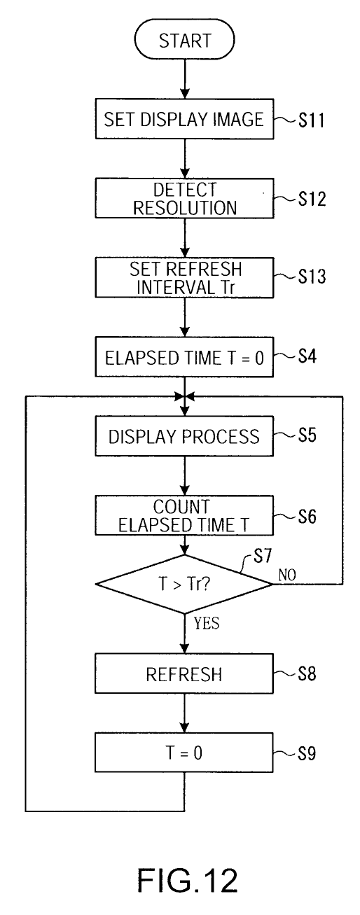

More specifically, the controller 42 of the timepiece 1B according to this embodiment of the invention first sets the image to be displayed on the display panel 30 (S11) as shown in FIG. 12.

The image is selected by the user manipulating the crown 5 or buttons 6 and 7. In the example shown in FIG. 10 a family crest having a vine and leaf motif in a circle is selected, and in FIG. 11 a family crest having three stars in a circle is selected.

The controller 42 then determines the resolution of the selected image (S12). The controller 42 determines the vine and leaf motif shown in FIG. 10 is a detailed image because of the white lines in the leaf portions. The crest shown in FIG. 11 is a simple combination of circles and a ring, however, and the controller 42 determines it to be a simple or low resolution image.

The images and degree of detail (resolution) are previously stored in the controller 42 so that when the image is selected the controller 42 automatically knows whether it is a fine detailed image or a simple image.

The controller 42 then sets the refresh interval Tr based on the detected resolution of the image. More specifically, if the controller 42 determines the image is a detailed high resolution image, the display quality of the image is subject to degradation and the refresh time interval is therefore set short.

However, if the controller 42 determines the image is a simple low resolution image, the display quality of the image does not degrade as easily and the refresh time interval is set long.

The display process then proceeds as described in the first embodiment. More specifically, the controller 42 initializes the elapsed time T (S4), displays the selected image (S5), and then measures the elapsed time T (S6).

The controller 42 then checks if the elapsed time T exceeds the refresh interval Tr (S7). If not, the display process (S5) and the elapsed time measuring process (S6) repeat.

If the elapsed time T exceeds the refresh interval Tr, the controller 42 refreshes the display (S8), resets the elapsed time T (S9), and then continues with display process (S5) and the elapsed time measuring process (S6).

If the display image is selected again, for example, the controller 42 executes the process from S11 to S9 again.

This embodiment achieves the same effects (1) and (2) as the first embodiment described above.

More particularly, this timepiece 1B sets the refresh time interval based on the resolution or amount of detail in the image displayed on the display panel 30. Detailed images that are subject to easy display degradation are therefore refreshed at a short interval to prevent degradation while simple images that are not easily subject to display degradation are refreshed at a long interval to reduce power consumption, and image quality can therefore be maintained while power consumption can also be reduced.

### Other Embodiments of the Invention

Preferred embodiments of the invention are described above but the invention is not so limited and can be varied and improved in many ways without departing from the scope of the accompanying claims.

The first embodiment sets the refresh time interval based on the font type and size, but the refresh time interval can be set based only on the font type. In a wristwatch, for example, the size of the display panel 30 is limited and the size of the displayed characters is therefore also limited to a certain range. In such situations the refresh time interval can be set based only on the font type.

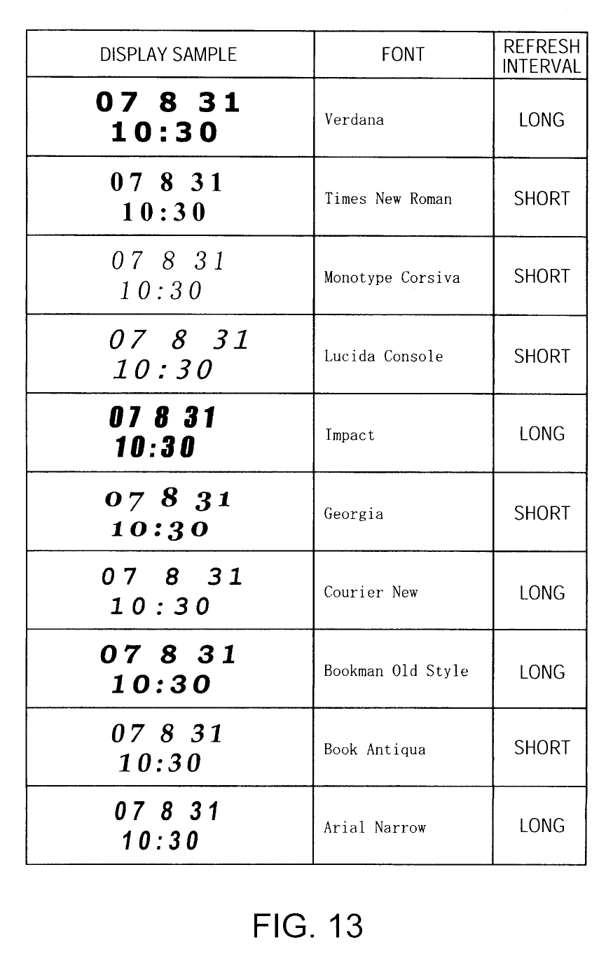

FIG. 13 shows sample refresh time intervals for a variety of different alphabetic fonts. In the examples shown in FIG. 13 the display of fonts such as Verdana and Impact that have generally heavy line widths in both numbers and letters is more resistant to degradation, and the refresh time interval is therefore set long.

Fonts such as Times New Roman with narrow line widths in numbers and letters are more subject to display degradation, however, and the refresh time interval is therefore set short.

Although not shown in the figure, the refresh time interval can be similarly set for Japanese fonts, for example.

The refresh time interval can also be set based only on the character display size. For example, if characters can be displayed in two sizes, large and small, the refresh time interval can be set long if the size is large regardless of the font type, and the refresh time interval can be set short if the size is small.

When text and images are displayed on the display panel 30, the amount of image detail (resolution), and the font type and size of the text, can be determined, and the refresh time interval can be set to the shortest refresh time interval appropriate to the evaluated conditions.

Yet further, if text and images are displayed on the display panel 30, a short refresh time interval can be set unconditionally.

If no image is displayed, such as when the display is solid white or solid black, a long refresh time interval can be set unconditionally. When the display is solid white or solid black, the refresh time interval can be set differently for a solid white display and a solid black display based on the color of the capsules (generally transparent) and the characteristics (such as the size, weight, and charged state) of the white and black particles.

The foregoing embodiments of the invention describe only two refresh time intervals, long and short, but the refresh time interval can be switched among three or more levels.

The content displayed on the display panel 30 is also not limited to the foregoing embodiments. For example, the invention can be applied in a display device with a wireless communication function, such as a cell phone, that displays the content of received mail on the display panel 30.

The foregoing embodiments of the invention are also described using a black and white two particle electrophoretic display having black particles 331 and white particles 331, but the invention is not so limited and could be a single particle display using a blue/white particles or a combination of colors other than black and white.

The display device of the invention can be applied to a wide range of electronic devices that have a display panel, including, for example, personal digital assistant (PDA) devices, cell phones, digital cameras, video cameras, printers, and personal computers.

The best modes and methods of achieving the present invention are described above, but the invention is not limited to these embodiments. More specifically, the invention is particularly shown in the figures and described herein with reference to specific embodiments, but it will be obvious to one with ordinary skill in the related art that the shape, material, number, and other detailed aspects of these arrangements can be varied in many ways without departing from the technical concept or the scope of the object of this invention.

Therefore, description of specific shapes, materials and other aspects of the foregoing embodiments are used by way of example only to facilitate understanding the present invention and in no way limit the scope of this invention, and descriptions using names of parts removing part or all of the limitations relating to the form, material, or other aspects of these embodiments are also included in the scope of this invention.

What is claimed is:

1. A display device, comprising:
a display panel having an electrophoretic device; and
drive control means that controls displaying content on the display panel;
wherein the drive control means evaluates the display data displayed on the display panel and changes the refresh time interval of the display panel according to the content of the display data.

2. The display device described in claim 1, wherein the drive control means refreshes the display panel at
a first refresh time interval when text data displaying text is contained in the display data and the display size of the text is smaller than a preset predetermined size, and
at a second refresh time interval that is longer than the first refresh time interval when text data displaying text is contained in the display data and the display size of the text is greater than or equal to the preset predetermined size.

3. The display device described in claim 1, wherein the drive control means refreshes the display panel at
a first refresh time interval when text data displaying text is contained in the display data and the font type of the text is a preset first font type, and
a second refresh time interval that is longer than the first refresh time interval when text data displaying text is contained in the display data and the font type of the text is a preset second font type.

4. The display device described in claim 3, wherein the first font type is a font in which the thickness of the lines rendering the characters varies, and the second font type is a font in which the thickness of the lines rendering the characters is substantially constant.

5. The display device described in claim 1, wherein the drive control means refreshes the display panel at
a first refresh time interval when image data displaying an image is contained in the display data and the image is determined to be a detailed image, and
a second refresh time interval that is longer than the first refresh time interval when the image is determined to be a simple image.

6. The display device described in claim 2, wherein the drive control means refreshes the display panel at the first refresh time interval when text data displaying text and image data displaying an image is contained in the display data.

7. A display method for operating a display device with a display panel having an electrophoretic device, comprising a step of:
evaluating data displayed on the display panel and changing the refresh time interval of the display panel according to the content of the display data.
